(19) United States
(12) Patent Application Publication
(10) Pub. No.: US 2021/0256865 A1
(43) Pub. Date: Aug. 19, 2021

(54) DISPLAY SYSTEM, SERVER, DISPLAY METHOD, AND DEVICE

(71) Applicant: Panasonic Intellectual Property Management Co., Ltd., Osaka (JP)

(72) Inventors: SHINICHI KOSHIBA, Osaka (JP); TOSHIKI KUMA, Osaka (JP)

(21) Appl. No.: 17/251,947

(22) PCT Filed: Aug. 23, 2019
(86) PCT No.: PCT/JP2019/032936

§ 371 Date: Dec. 14, 2020

(30) Foreign Application Priority Data
Aug. 29, 2018 (JP) 2018-160498
Jun. 12, 2019 (JP) 2019-109900

(51) Int. Cl. G09B 9/00; G06F 3/01

(52) U.S. Cl. CPC G09B 9/00; G06F 3/04842; G06F 3/011

(57) ABSTRACT

The display system includes a detector, a display, and an operator. The detector detects position information of an education target person. The display displays an image viewed from a viewpoint of the education target person corresponding to the position information in a virtual space. The operator selects an education target object included in the image. When the education target object is selected by operating the operator, the display displays educational content of equipment associated with the education target object.

### TECHNICAL FIELD

The present disclosure relates to a display system, a server, a display method and a device (particularly an educational device).

### BACKGROUND ART

There is known a system by which a worker can simulate a situation when a disaster occurs to improve safety awareness of the worker at a work site (for example, see Patent Document 1).

### CITATION LIST

### Patent Literature

PTL 1: Japanese Patent Unexamined Publication No. 2001-356680

### SUMMARY OF THE INVENTION

A display system of the present disclosure is a system for providing education relating to equipment of a factory. The display system includes a detector, a display, and an operator.

The detector detects position information of an education target person.

The display displays an image viewed from a viewpoint of the education target person corresponding to the position information, in a virtual space of the factory in which an education target object associated with the equipment and having a shape of the equipment is disposed.

The operator selects the education target object included in the image.

When the education target object is selected by operating the operator, the display displays educational content of equipment associated with the education target object.

A server of the present disclosure is a server for outputting educational content for providing education relating to equipment of a factory.

The server includes an acquisitor, an image output unit, and a content output unit.

The acquisitor acquires position information of an education target person from a detector.

The image output unit outputs an image viewed from a viewpoint of the education target person corresponding to the position information to the display, in a virtual space of the factory in which an education target object associated with the equipment and having a shape of the equipment is disposed.

The content output unit outputs educational content of equipment associated with the education target object to the display when the education target object included in the image is selected.

A display method of the present disclosure is a display method of displaying content for providing education relating to equipment of a factory.

The display method receives position information of an education target person detected by a detector, outputs information for displaying an image viewed from a viewpoint of the education target person corresponding to the position information to a display device, in a virtual space of the factory in which an education target object associated with the equipment and having a shape of the equipment is disposed, and outputs information for displaying educational content of equipment associated with the education target object to the display device when the education target object included in the image displayed on the display device is selected.

A device of the present disclosure is a device for providing education relating to equipment of a factory.

The device includes a processor and a memory.

The memory stores a program executable by the processor.

The processor uses the program stored in the memory to receive position information of an education target person from a detector, generate an image viewed from a viewpoint of the education target person corresponding to the position information, in a virtual space of the factory in which an education target object associated with the equipment and having a shape of the equipment is disposed, output the image to a display device, and output educational content of equipment associated with the education target object to the display device when the education target object included in the image is selected by operating an operator.

### BRIEF DESCRIPTION OF DRAWINGS

FIG. 1 is a schematic diagram illustrating an outline of a display system according to an embodiment.

FIG. 2 is a block diagram illustrating a configuration example of the display system according to the embodiment.

FIG. 3 is a sequence diagram illustrating an operation of the display system according to the embodiment.

FIG. 4 is a flowchart illustrating an operation of a server according to the embodiment.

FIG. 5 is a schematic diagram illustrating a state of a virtual space according to the embodiment.

FIG. 6 is a diagram illustrating an example of a display screen according to the embodiment.

FIG. 7 is a diagram illustrating an example of the display screen according to the embodiment.

FIG. 8 is a diagram illustrating an example of the display screen according to the embodiment.

FIG. 9 is a diagram illustrating an example of the display screen according to the embodiment.

FIG. 10 is a diagram illustrating an example of the display screen according to the embodiment.

FIG. 11 is a flowchart of a modification example of the operation of the server according to the embodiment.

FIG. 12 is a diagram illustrating an example of the display screen according to the embodiment.

FIG. 13 is a flowchart of educational content output processing according to the embodiment.

FIG. 14 is a diagram illustrating an example of a display screen at the time of risk assuming training according to the embodiment.

FIG. 15 is a diagram illustrating an example of a display screen at the time of accident scenario experience according to the embodiment.

FIG. 16 is a diagram illustrating an example of the display screen at the time of the accident scenario experience according to the embodiment.

FIG. 17 is a diagram illustrating an example of the display screen at the time of the accident scenario experience according to the embodiment.

FIG. 18 is a diagram illustrating an example of a display screen at the time of questioning according to the embodiment.

FIG. 19 is a diagram illustrating an example of a display screen at the time of presenting an action to be taken according to the embodiment.

FIG. 20 is a diagram illustrating an example of the display screen at the time of presenting the action to be taken according to the embodiment.

### DESCRIPTION OF EMBODIMENTS

A display system according to one aspect of the present disclosure is a system that provides education relating to equipment of a factory (facility). The display system includes a detector, a display, and an operator.

The detector detects position information of an education target person.

The display displays an image viewed from a viewpoint of the education target person corresponding to the position information to the education target person, in a virtual space of the factory in which an education target object associated with the equipment to become an education target and having a shape of the equipment is disposed.

The operator is used for the education target person to select an education target object included in the image.

When the education target person selects an education target object by using the operator, the display displays educational content of equipment associated with the education target object to the education target person.

According to this, an education target person performs an active operation of selecting an education target object in a virtual space. Thereby, there is a possibility that an effect of education for the education target person can be improved. Further, the education target person performs an operation of searching for an object to become an education target in the virtual space. Thereby, effective education can be performed as compared to a case where the education target person simply watches educational content. Further, the education target person selects the equipment having a shape of an education target. Thereby, it is possible to reduce a wrong selection of the educational content as compared to a case of selecting an icon in which, for example, only an equipment name of an education target is described.

For example, the display may display an icon on the education target object or around the education target object when the image includes the education target object. Then, when the education target person selects the icon by using the operator, the display may display the educational content to the education target person.

Thereby, an education target person easily finds an education target object. Thus, it is possible to suppress an increase in information processing amount and a decrease in motivation of an education target person due to excessive elapse of time without finding the education target object by the education target person.

For example, the display may display a pointer pointing to a position on the image based on an operation of the education target person. Then, when the education target person performs a selection operation by using the operator in a state where the icon is pointed by the pointer, the display may display the educational content to the education target person.

According to this, an education target person can intuitively select an education target object. Therefore, it is possible to reduce wrong selection.

For example, the display may display a pointer pointing to a position on the image based on an operation of the education target person. Then, when the education target person performs a selection operation by using the operator in a state where the education target object is pointed by the pointer, the display may display the educational content to the education target person.

According to this, an education target person can intuitively select an education target object. Therefore, it is possible to reduce wrong selection.

For example, the display may display a pointer pointing to a position on the image based on an operation of the education target person. Then, when the education target object is pointed by the pointer, the display may display an icon on the education target object or around the education target object. Then, when the education target person performs a selection operation by using the operator in a state where the icon is displayed, the display may display the educational content to the education target person.

According to this, an education target person easily finds an education target object. Thus, it is possible to suppress an increase in information processing amount due to excessive elapse of time and a decrease in motivation of an education target person without finding an education target object by the education target person. Further, since it is difficult to find an education target object as compared to a case where an icon is constantly displayed, an education target person needs thought. Thereby, an effect of education can be improved.

For example, the educational content may include a virtual experience in the virtual space.

According to this, an effect of education can be improved by a realistic experience. Further, it is unnecessary to separately prepare an apparatus for providing a virtual experience in a virtual space, and thus, a configuration of a device is simplified.

For example, the virtual experience may include a risk experience on the education target object.

According to this, safety training can be effectively performed. Further, it is unnecessary to separately prepare an apparatus for providing an actual risk experience, and thus, a configuration of a device is simplified.

For example, the educational content may include a question to the education target person on the risk experience.

According to this, since it is possible to urge thought of an education target person, an effect of education can be improved. Further, it is unnecessary to separately prepare an apparatus for questioning about a risk experience, and thus, a configuration of a device can be simplified.

For example, the educational content may include content relating to the risk experience and indicating an action to be taken by the education target person.

According to this, an effect of education can be improved. Further, it is unnecessary to separately prepare an apparatus for displaying content indicating an action to be taken by an education target person, and thus, a configuration of a device is simplified.

For example, the educational content may include content related to the education target object and causing the education target person to select a risky place.

According to this, since it is possible to urge thought of an education target person, an effect of education can be improved. Further, it is unnecessary to separately prepare an apparatus for displaying the content for causing an education target person to select a risky place, and thus, a configuration of a device is simplified.

For example, the virtual space may be generated by using an image obtained by imaging a target facility.

According to this, since it is possible to generate a virtual space close to an actual state of a target facility, realism can be improved. Further, it is unnecessary to separately prepare an image obtained by imaging a target facility, and thus, a configuration of a device is simplified.

For example, the display system may further include a vibrator that vibrates the education target person according to content of the educational content.

According to this, an effect of education can be improved by a realistic experience. Further, it is unnecessary to separately prepare an apparatus that vibrates an education target person, and thus, a configuration of a device is simplified.

A server according to an aspect of the present disclosure is a server for outputting educational content for providing education relating to equipment of a factory. The server includes an acquisitor, an image output unit, and a content output unit.

The acquisitor acquires position information of an education target person from a detector.

The image output unit outputs an image viewed from a viewpoint of the education target person corresponding to the position information to a display, in a virtual space of the factory in which an education target object associated with the equipment to become an education target and having a shape of the equipment is disposed.

The content output unit outputs educational content of equipment associated with the education target object to the display when the education target person selects the education target object included in the image.

According to this, an education target person performs an active operation of selecting an education target object in a virtual space. Thereby, there is a possibility that an effect of education for the education target person can be improved. Further, since an education target person performs an operation of searching for an object to become an education target in a virtual space, an effective education can be performed as compared to a case where the education target person simply watches educational content. Further, the education target person selects the equipment having a shape of an education target. Thereby, wrong selection of educational content can be reduced as compared to a case of selecting an icon in which, for example, an equipment name of an education target is described.

A display method according to an aspect of the present disclosure is a display method of displaying content for providing education relating to equipment of a factory.

The display method of the present disclosure receives position information of an education target person detected by a detector, outputs information for displaying, to the education target person, an image viewed from a viewpoint of the education target person corresponding to the position information to a display device, in a virtual space of the factory in which an education target object associated with the equipment to become an education target and having a shape of the equipment is disposed, and outputs information for displaying, to the education target person, educational content of equipment associated with the education target object to the display device when the education target person selects the education target object included in the image displayed on the display device.

According to this, an education target person performs an active operation of selecting an education target object in a virtual space. Thereby, there is a possibility that an effect of education for the education target person can be improved. Further, since an education target person performs an operation of searching for an object to become an education target in a virtual space, an effective education can be performed as compared to a case where the education target person simply watches educational content. Further, the education target person selects the equipment having a shape of an education target. Thereby, wrong selection of educational content can be reduced as compared to a case of selecting an icon in which, for example, an equipment name of an education target is described.

A device according to an aspect of the present disclosure is a device for providing education relating to equipment of a factory. The device includes a processor and a memory.

A program executable by the processor is stored in the memory.

the processor uses the program stored in the memory to receive position information of an education target person from a detector, generate an image viewed from a viewpoint of the education target person corresponding to the position information, in a virtual space of the factory in which an education target object associated with equipment to become an education target and having a shape of the associated equipment is disposed, output the image to a display device to display for the education target person, and output educational content of equipment associated with the education target object to the display device to display the educational content to the education target person when the education target person selects an education target object included in the image by using an operator.

According to this, an education target person performs an active operation of selecting an education target object in a virtual space. Thereby, there is a possibility that an effect of education for the education target person can be improved. Further, since an education target person performs an operation of searching for an object to become an education target in a virtual space, an effective education can be performed as compared to a case where the education target person simply watches educational content. Further, the education target person selects the equipment having a shape of an education target. Thereby, wrong selection of educational content can be reduced as compared to a case of selecting an icon in which, for example, an equipment name of an education target is described.

These comprehensive or specific aspects may be realized by a system, a method, an integrated circuit, a computer program, or a recording medium such as a computer-readable CD-ROM. Further, the aspects may be realized by a certain combination of the system, the method, the integrated circuit, the computer program, and the recording medium.

Hereinafter, embodiments will be specifically described with reference to the drawings.

Each of the embodiments described below illustrates a specific example of the present disclosure. Numerical values, shapes, materials, configuration elements, arrangement positions and connection forms of configuration elements, steps, order of steps, and the like illustrated in the following embodiments are examples and are not intended to limit the present disclosure. Further, among configuration elements in the following embodiments, configuration elements not described in the independent claims representing the highest concept are described as certain configuration elements.

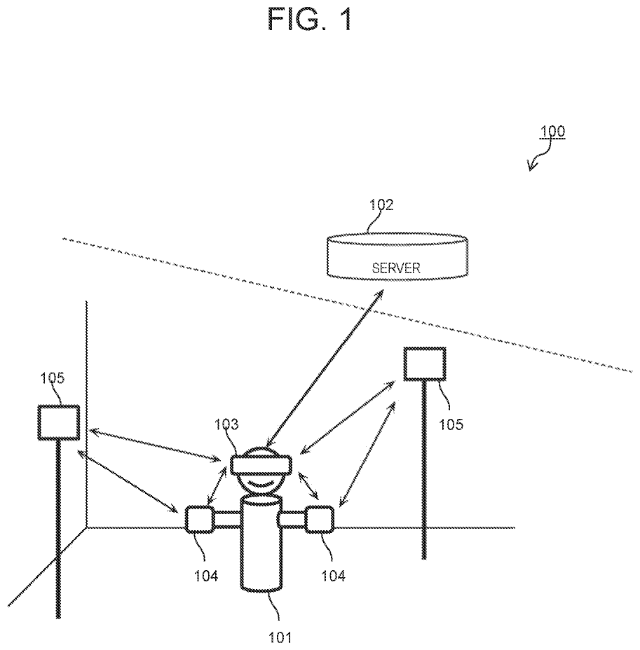

FIG. 1 is a schematic diagram illustrating an outline of display system 100 according to the present embodiment. In the following, an example will be described in which display system 100 is a system for providing safety education to workers who perform manufacturing work or the like in a facility such as a factory. Usage of display system 100 is not limited thereto. For example, display system 100 can be used for safety education in any facility such as a school, a hospital, and a research facility without being limited to the factory. Further, display system 100 can be used not only for the safety education but also for other educational purposes such as education on how to use a device.

Display system 100 includes headset 103 and two controllers 104. Further, display system 100 may include server 102 and two position sensors 105. Display system 100 is, for example, a system for providing education relating to equipment of a factory (facility). In the present embodiment, two controllers 104 and two position sensors 105 are used. However, the number of controllers 104 is not limited to two and may be one or three or more. Further, the number of position sensors 105 may be one, or three or more.

Headset 103 is worn on the head of education target person 101 who receives safety education. Two controllers 104 are held in both hands of education target person 101. Two position sensors 105 are used to detect positions of headset 103 and controller 104s.

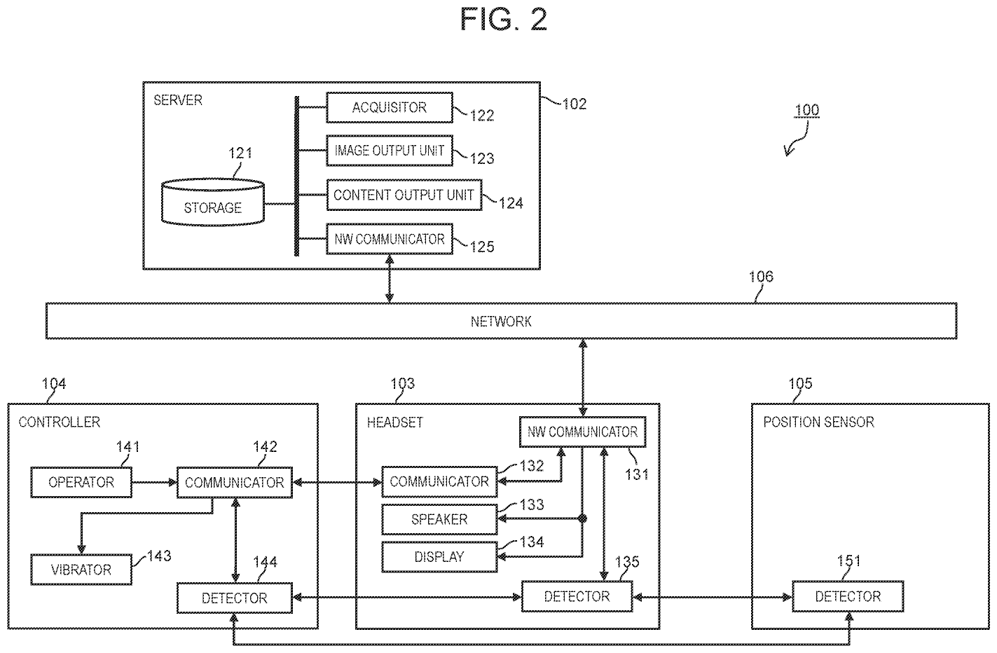

FIG. 2 is a block diagram of display system 100. As illustrated in FIG. 2, server 102 is connected to headset 103 via network 106. Server 102 generates an image and sound to be reproduced by headset 103 based on a position of headset 103 and operation content of controller 104 by education target person 101 (see FIG. 1), and outputs the generated image and sound to headset 103. Server 102 includes storage 121, acquisitor 122, image output unit 123, content output unit 124, and network (NW) communicator 125.

Storage 121 stores three-dimensional information indicating a virtual space of a target facility such as a factory. A plurality of education target objects are disposed in the virtual space. Further, storage 121 stores a plurality of educational content associated with the plurality of education target objects. For example, the plurality of education target objects are respectively associated with a plurality of pieces of equipment becoming education targets. Each of the education target objects has a shape of the associated equipment. Further, the educational content of the education target objects is educational content of the equipment associated with the educational content.

The educational content includes an image (a moving image or a still image), sound, control information, and the like. The control information includes, for example, information for controlling vibration of controllers 104.

Further, the above-described three-dimensional information is, for example, a point cloud generated by using images obtained by imaging a target facility from a plurality of viewpoints. The three-dimensional information is not limited to information generated from the captured image and may be computer graphics. Further, the three-dimensional information may be a combination of information generated from the captured image and the computer graphics. Further, as a method of forming a virtual space, a 360-degree image obtained by imaging a target facility may be used, or a combination of the 360-degree image and the three-dimensional information (point cloud or the like) may be used.

Acquisitor 122 acquires position information of headset 103 and position information and operation content of controller 104 from headset 103.

Image output unit 123 generates an image viewed from a viewpoint of education target person 101 corresponding to a position of headset 103 in a virtual space based on the position of headset 103. The position in the present application includes, for example, three-dimensional coordinates and a posture (tilt). The position may be either one of the three-dimensional coordinates and the tilt, and two-dimensional coordinates (for example, lateral coordinates) may be used instead of the three-dimensional coordinates.

Further, when the generated image includes the education target object, image output unit 123 superimposes an icon of the education target object on the image and outputs the acquired image.

When education target person 101 selects an education target object included in a screen, content output unit 124 outputs educational content associated with the education target object to headset 103.

NW communicator 125 receives the position information of headset 103 and the position information and the operation content of controller 104 from headset 103 via network 106. In addition, NW communicator 125 transmits the image generated by image output unit 123 and the educational content to headset 103 via network 106.

Headset 103 reproduces the image, the sound, and the like transmitted from server 102. Headset 103 includes NW communicator 131, communicator 132, speaker 133, and display 134. NW communicator 131 receives the image, sound, control information, and the like transmitted from server 102. Further, NW communicator 131 transmits the position information of headset 103, the position information and the operation content of controller 104 to server 102 via network 106. A communication method between server 102 and headset 103 is not particularly limited, and any method such as a wired method or a wireless method may be used.

Communicator 132 communicates with controller 104. Specifically, communicator 132 transmits control information transmitted from server 102 to controller 104. Further, communicator 132 receives the position information and the operation content of controller 104 transmitted from controller 104 and outputs the received information to NW communicator 131.

Speaker 133 outputs sound transmitted from server 102. Display 134 displays an image transmitted from server 102.

Headset 103 includes detector 135. Detector 135 detects the position of headset 103 (education target person 101). Specifically, detector 151 included in position sensor 105 scan-irradiates an infrared laser. Detector 135 includes a plurality of light receivers. Each of the light receivers receives infrared laser emitted from two position sensors 105. Detector 135 detects the position of headset 103 based on an irradiation direction of the laser in detector 151 received by each of the light receivers and time from laser irradiation to reception. The detected position information of headset 103 is output to NW communicator 131.

Here, a method of using the infrared laser is exemplified as a position detection method, but the position detection method is not limited thereto, and any known method may be used. For example, headset 103 is provided with a plurality of light emitting units that emit infrared or visible light, and the position of headset 103 may be detected based on the image obtained by an infrared or visible light camera provided in position sensor 105.

Further, in addition to the information obtained by the position detection method described above, the position information of headset 103 may be calculated based on information obtained by a gyro sensor (not illustrated) and the like included in headset 103, and the position information may be calculated based only on the information obtained by the gyro sensor (not illustrated) and the like.

Controller 104 includes operator 141, communicator 142, vibrator 143, and detector 144. Operator 141 is an input interface for education target person 101 to select an education target object included in an image and accepts an operation of the education target person. For example, operator 141 is one or a plurality of operation buttons. A method of accepting the operation of the education target person is not limited thereto, and the operation may be accepted based on an operation of shaking controller 104, a posture of controller 104, and the like. Further, an input method of using a sound input or using another input device may be used, and a plurality of input methods may be used together.

Communicator 142 communicates with headset 103. Specifically, communicator 142 transmits operation content of operator 141 and position information of controller 104 to headset 103. Further, communicator 142 receives the control information transmitted from headset 103. Vibrator 143 is controlled based on the control information. Vibrator 143 vibrates education target person 101 according to content of educational content.

Although vibrator 143 included in controller 104 is configured to vibrate education target person 101 here, the vibrator included in headset 103 may vibrate education target person 101. Furthermore, headset 103, controller 104, or another device attached thereto may be provided with a device for giving education target person 101, for example, heat, wind, water, electrical stimulation, or tactile stimulation.

Further, a communication method between headset 103 and controller 104 is not limited in particular, and any method such as a wired method or a wireless method may be used.

Detector 144 detects a position of controller 104. A method of detecting a position is the same as the method of detecting the position of headset 103.

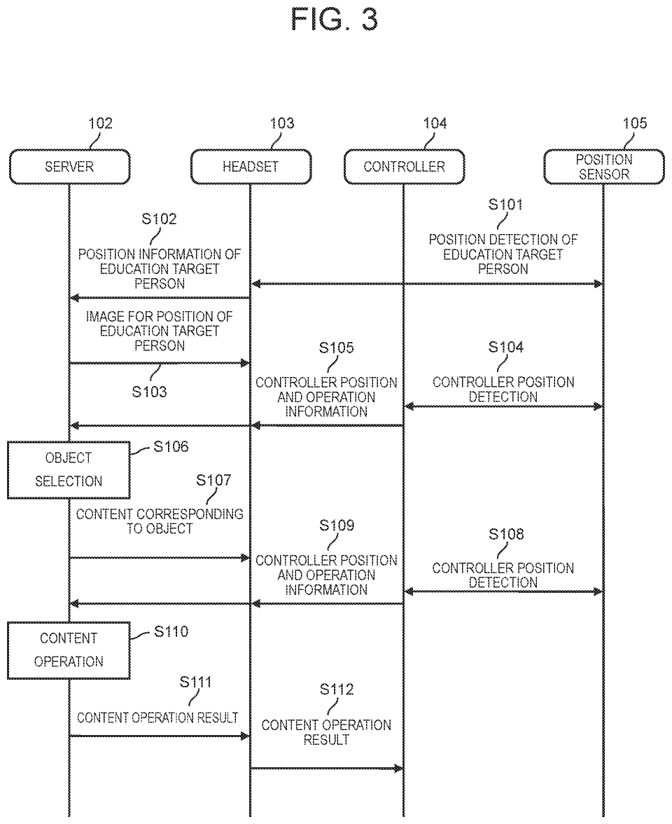

Next, an operation of display system 100 will be described. FIG. 3 is a sequence diagram illustrating a flow of operations of display system 100. First, headset 103 detects a position (position of headset 103) of education target person 101 (S101) and transmits the detected position information of the education target person to server 102 (S102).

Server 102 generates an image corresponding to the position of the education target person and transmits the generated image to headset 103 (S103). Processing of steps S101 to S103 is repeated every time the position of education target person 101 changes.

Further, if controller 104 is operated by education target person 101, controller 104 detects the position of controller 104 (S104), and transmits the position information of controller 104 and the operation information on operator 141 and the like to server 102 (S105).

When an education target object of education target content is selected by the above-described operation (S106), server 102 transmits educational content corresponding to the selected education target object to headset 103 (S107).

Further, if controller 104 is operated by the education target person 101, controller 104 detects the position of controller 104 (S108) and transmits the position information of controller 104 and the operation information on operator 141 and the like to server 102. (S109).

When the operation on the education target content is performed by the above-described operation (S110), server 102 transmits results of the operation to headset 103 and controller 104 (S111 and S112). Specifically, update of a screen displayed on headset 103, a vibration control of controller 104, and the like are performed.

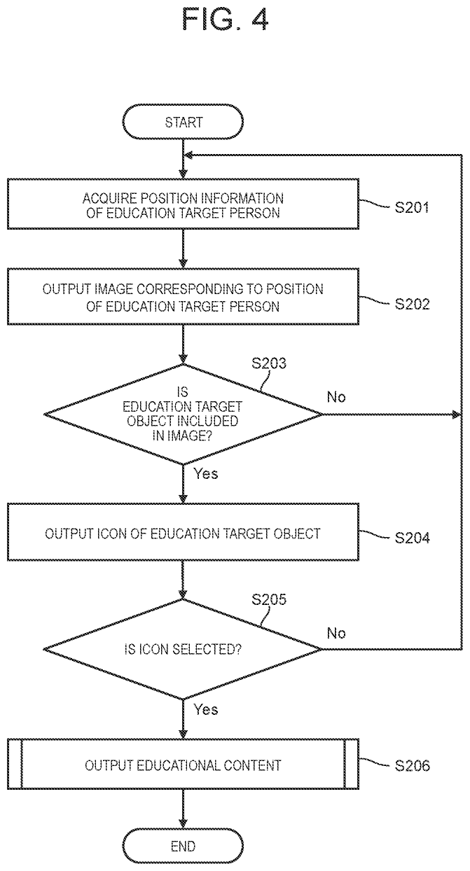

FIG. 4 is a flowchart of processing by server 102. First, server 102 acquires the position information (position information of headset 103) of education target person 101 (S201). Next, server 102 generates an image viewed from a viewpoint of education target person 101 corresponding to the acquired position information in the virtual space based on the three-dimensional information stored in the storage 121, and outputs the generated image to headset 103 (S202).

When the education target object is not included in the image (No in S203), step S201 and subsequent steps are performed again in a predetermined cycle.

When the image includes an education target object (Yes in S203), server 102 outputs an icon of the education target object (S204). Specifically, server 102 superimposes the icon on the image and outputs the generated image to headset 103.

In this state, when the icon is selected by the operation of education target person 101 (Yes in S205), server 102 outputs the educational content associated with the selected icon to headset 103 (S206). Meanwhile, when the icon is not selected by the operation of education target person 101 (No in S205), step S201 and subsequent steps are performed again in a predetermined cycle.

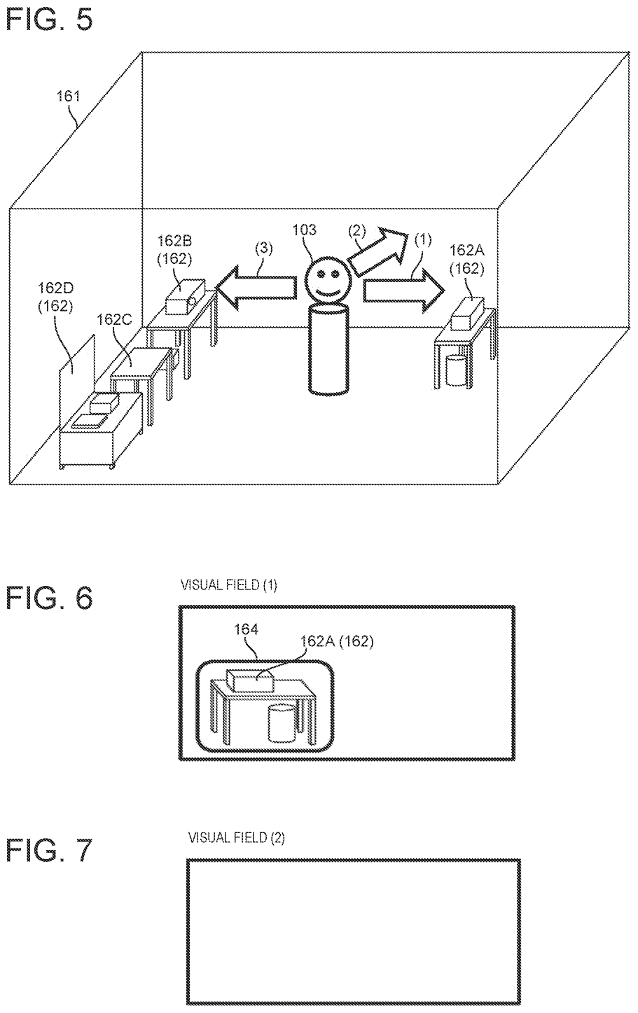

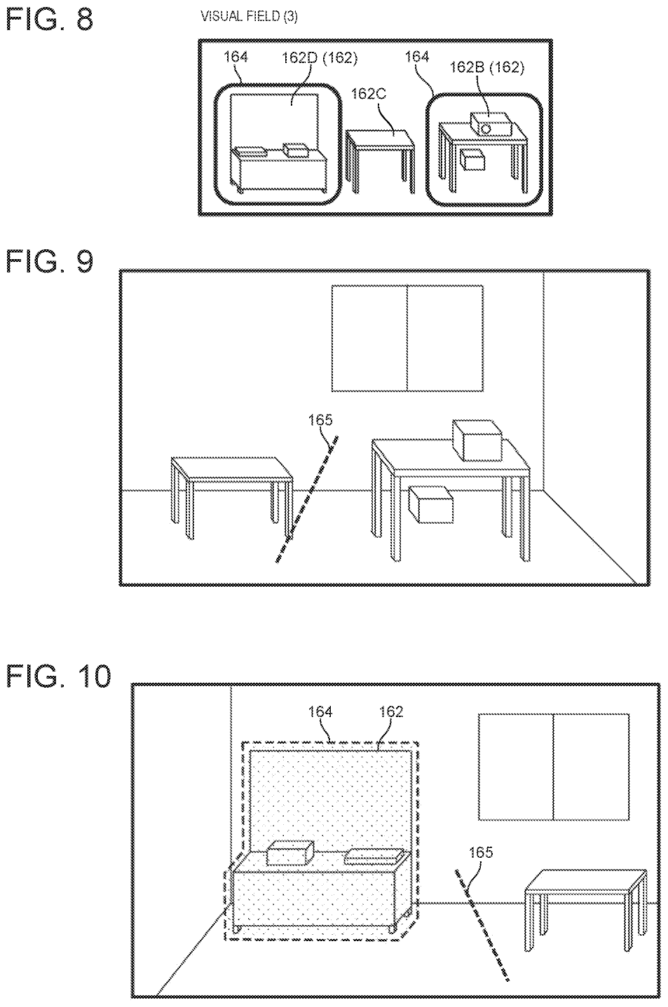

FIG. 5 is a schematic diagram illustrating an example of virtual space 161 of a target facility. In the example illustrated in FIG. 5, four objects 162A to 162D such as equipment are disposed in the virtual space. Objects 162A, 162B, 162D are education target objects 162 associated with educational content. Object 162C is a normal object that is not an education target object. FIGS. 6 to 8 are diagram illustrating examples of display screens of visual field (1) to visual field (3) respectively illustrated in FIG. 5. As illustrated in FIGS. 6 and 8, when the education target objects 162 (objects 162A, 162B, and 162D) are included in the screens, icon 164 is displayed in association with the education target object. For example, icon 164 is displayed around the education target object or is displayed to be overlaid on the education target object. For example, icon 164 is for highlighting the education target object. Further, icon 164 may include character information, a graphic, and the like that describes an education target object or educational content associated with the education target object.

Further, as illustrated in FIG. 8, icon 164 is not displayed on normal object 162C. Further, as illustrated in FIG. 7, when an image does not include the education target object, icon 164 is not displayed.

FIGS. 9 and 10 are diagrams illustrating detailed examples of display screens. As illustrated in FIG. 9, pointer 165 that is a laser pointer is displayed on a screen. Pointer 165 points to a certain position in the screen according to an orientation of controller 104.

In the example of FIG. 9, an education target object is not included in the screen. In this case, education target person 101 searches for the education target object by changing a line-of-sight direction or moving a position. In the example of FIG. 10, education target object 162 is included in the screen, and icon 164 is displayed to be overlaid on education target object 162. In this state, education target person 101 selects icon 164 by pointing icon 164 with the pointer 165 and performing a selection operation (for example, pressing of an operation button) with operator 141.

As described above, when education target person 101 performs the selection operation with operator 141 in a state where education target object 162 is pointed by pointer 165, educational content is displayed on a screen of display 134. By displaying icon 164, education target person 101 can easily find education target object 162. Thus, it is possible to suppress excessive elapse of time and a decrease in motivation of education target person 101 without finding education target object 162 by education target person 101.

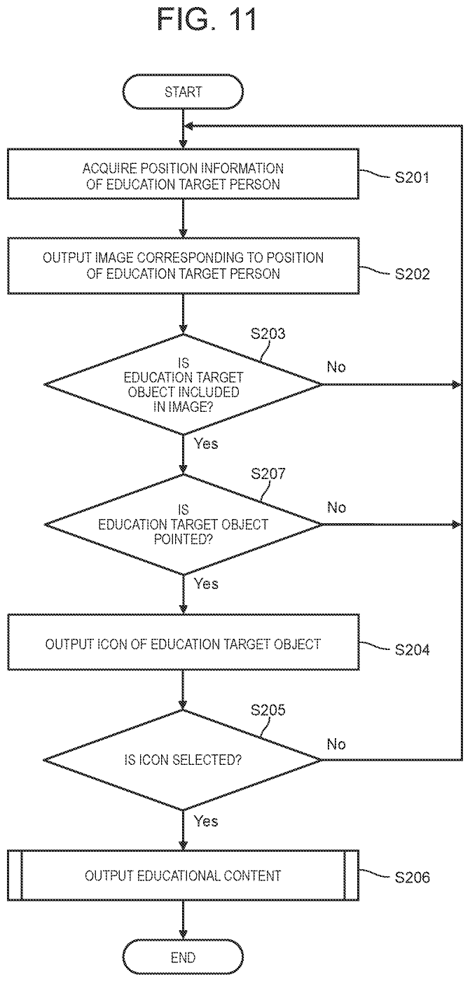

Although an example in which icon 164 is constantly displayed is described here, icon 164 may be displayed only when the education target object 162 is pointed by pointer 165. FIG. 11 is a flowchart of an operation of server 102 in this case. In the processing illustrated in FIG. 11, step S207 is added to the processing illustrated in FIG. 4. Specifically, in a case where an image includes education target object 162 (Yes in S203), when education target object 162 is pointed by pointer 165 (Yes in S207), server 102 outputs icon 164 (S204). Further, when the education target object is not pointed by pointer 165 (No in S207), server 102 does not output icon 164.

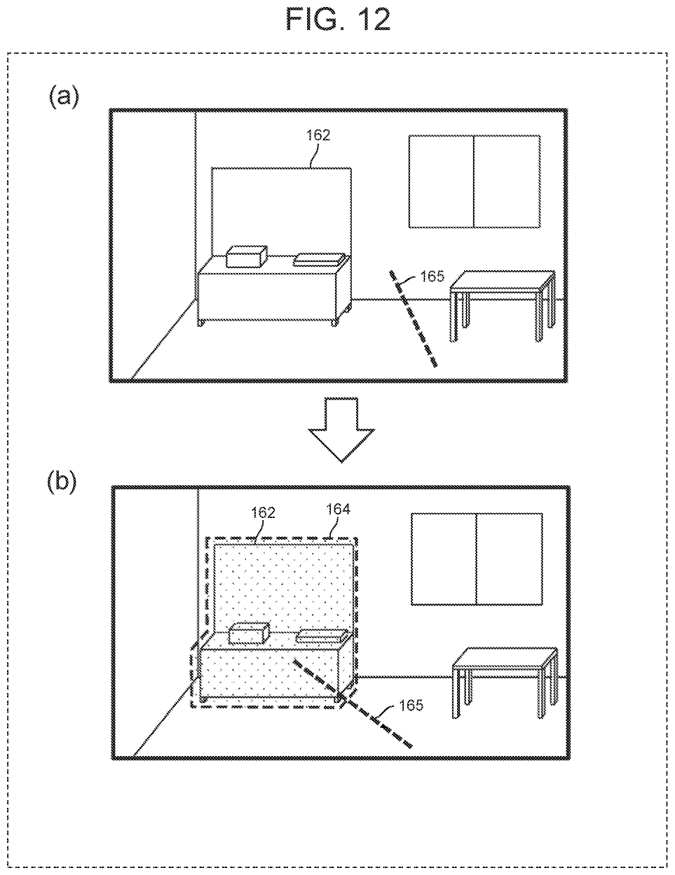

FIG. 12 is a diagram illustrating an example of a screen at this time. As illustrated in (a) of FIG. 12, even in a case where the education target object 162 is included in the screen, when pointer 165 does not point to education target object 162, icon 164 is not displayed. As illustrated in (b) of FIG. 12, when pointer 165 points to education target object 162, icon 164 is displayed.

As such, when education target object 162 is pointed by pointer 165, icon 164 is displayed. When education target person 101 performs a selection operation (for example, pressing of an operation button) with operator 141 in a state where icon 164 is displayed, educational content is displayed on a screen of display 134.

Thereby, it is more difficult to find an education target object as compared to when the icon is constantly displayed, and thus, an education target person needs to think. Thereby, an effect of education can be improved. Further, since icon 164 is displayed when being pointed by pointer 165, it is possible for education target person 101 to find education target object 162 more easily than when icon 164 is not displayed at all.

Icon 164 may not be displayed even when pointer 165 points to education target object 162. Thereby, it is more difficult to find the education target object. That is, when education target person 101 performs a selection operation (for example, pressing of an operation button) with operator 141 in a state where education target object 162 is pointed by pointer 165, educational content may be displayed on the screen of display 134.

Further, icon 164 may be displayed on both education target object 162 and a normal object. Also in this case, when education target object 162 is selected, educational content is reproduced, and when the normal object is selected, the educational content is not reproduced. Thereby, a selectable candidate can be presented to education target person 101, and thus, it is possible to easily find the education target object. Meanwhile, as compared to when icon 164 is displayed only on education target object 162, it is difficult to select education target object 162.

A plurality of methods described above may be settable. Further, a method to be used may be switched according to a predetermined condition. For example, when education target object 162 is not selected for a predetermined time, that is, when education target person 101 cannot find education target object 162, the method to be used may be switched to a method that is easier to select.

As described above, education target person 101 performs an active operation of selecting education target object 162 in a virtual space. Thereby, there is a possibility that an education effect on education target person 101 can be improved. Further, education target person 101 performs an operation of searching for an object to be targeted for education in the virtual space, and thus, effective education can be performed as compared to when education target person 101 simply watches the educational content.

Both coordinates and a posture of education target person 101 (headset 103) may be used as a method of realizing the virtual space, or the coordinates may be fixed and the screen may be changed based on the posture. Further, movement of the coordinates may not be performed by movement of education target person 101 but may be performed by an operation of controller 104 or the like by education target person 101. Further, only two-dimensional or one-dimensional movement may be reflected, such as only the horizontal direction or only the vertical direction. Likewise, only a change in posture in a particular direction may be reflected.

Further, stereoscopic display for displaying different images having parallax in the left and right eyes may be used, or a method by which the same image is displayed in the left and right eyes may be used.

The method of realizing the virtual space is the same for a virtual experience included in the educational content described below.

Next, details of the educational content will be described. The educational content includes, for example, a virtual experience in a virtual space. Further, the virtual experience includes, for example, a risk experience on education target object 162.

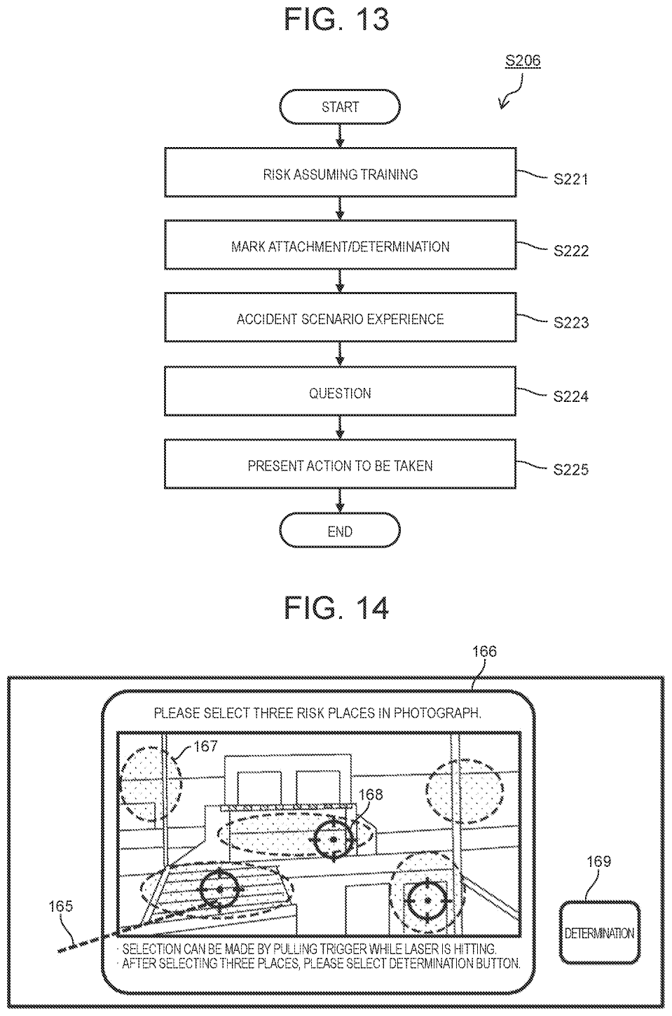

FIG. 13 is a flowchart of reproduction processing (S206 in FIG. 4) of the educational content. First, a screen of risk assuming training is displayed on headset 103 (S221). The risk assuming training is, for example, content relating to education target object 162 and causing education target person 101 to select a risky place.

FIG. 14 is a diagram illustrating an example of a display screen at the time of risk assuming training. As illustrated in FIG. 14, risk assuming training screen 166 is displayed. On risk assuming training screen 166, a photograph of an education target object is displayed, and a plurality of places are marked as risk candidates 167. Education target person 101 selects risk candidate 167 with pointer 165 and presses operator 141 (operation button) to add selection mark 168. Education target person 101 selects determination button 169 after adding selection mark 168. Thereby, a result of a correct answer or an incorrect answer according to the selection result is displayed (S222).

Although the plurality of risk candidates 167 are displayed here, a method of marking a certain position may be used. Further, the number of places to be selected may not be plural. Further, the question is not limited to content for selecting a risk place and may be an any question on the risk assuming training of education target object 162.

Further, although an example in which a two-dimensional image is displayed is described here, a method of selecting a risk place in a virtual space may be used.

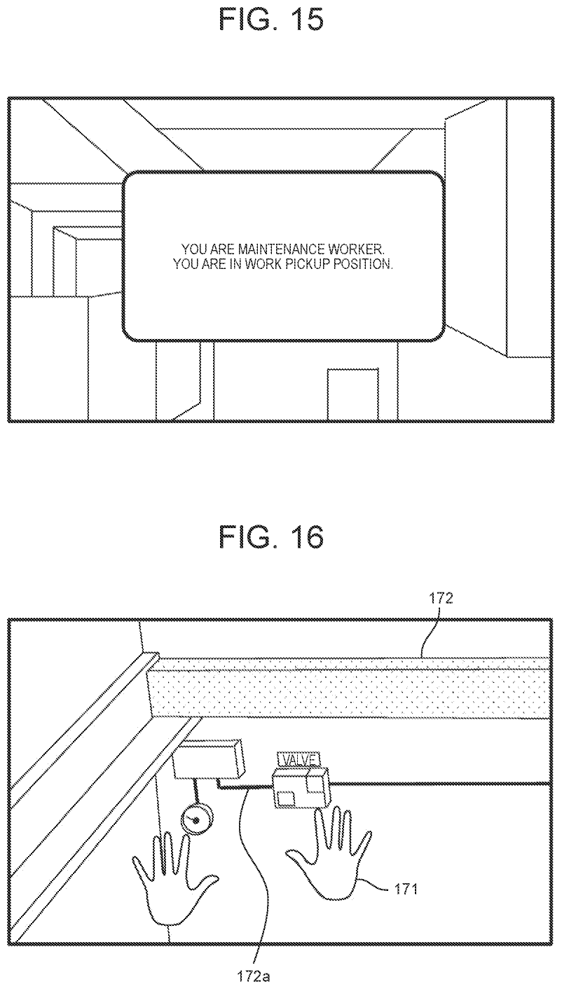

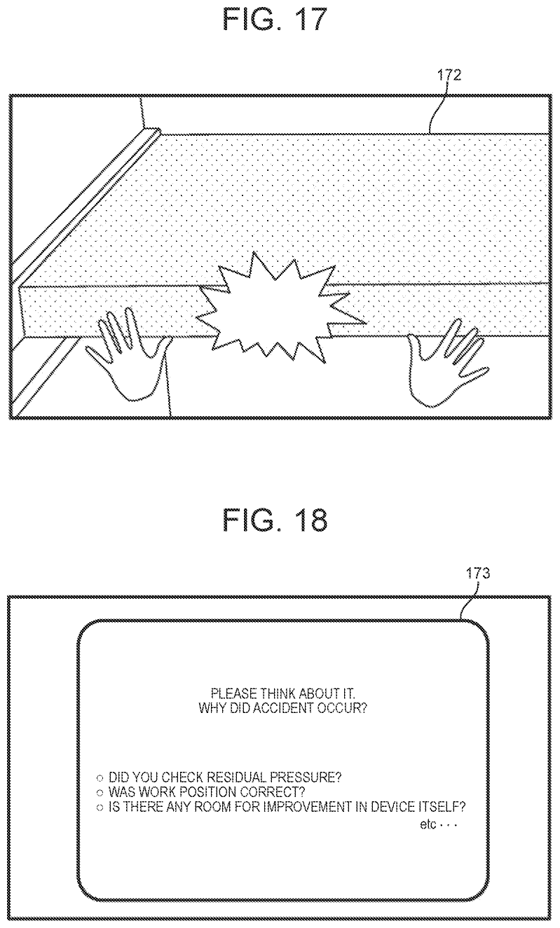

Next, an accident scenario for virtually experiencing a risk experience such as an accident or a risk state starts (S223). FIGS. 15 to 17 are diagrams illustrating examples of screens of accident scenarios. Here, as illustrated in FIG. 15, an example in which work of a maintenance worker is virtually experienced will be described. As illustrated in FIG. 16, controller 104 operates hand 171 in s virtual space. For example, an operation of holding hand 171 is performed by operating operator 141 (operation button). Further, this example shows an experience when a device fails. As illustrated in FIG. 17, for example, an accident in which, when tube 172a (see FIG. 16) is pulled out, driver 172 pops out due to a residual pressure, and driver 172 collides with a worker is reproduced. For example, controller 104 is controlled to vibrate during a collision. Further, in an accident scenario, sounds such as environmental sounds and sound effects are reproduced along with a video. Vibrator 143 may not be embedded in controller 104 and may be separately mounted in education target person 101.

Next, a question to education target person 101 relating to the accident scenario is displayed (S224). FIG. 18 is a diagram illustrating an example of question screen 173. As illustrated in FIG. 18, for example, content of questioning to education target person 101 about cause of the accident, improvement points, and the like is displayed. Although an example in which an image is displayed is described here, the question may be made by sound or the like. Further, the question may be made to education target person 101 by a character or the like in the virtual space.

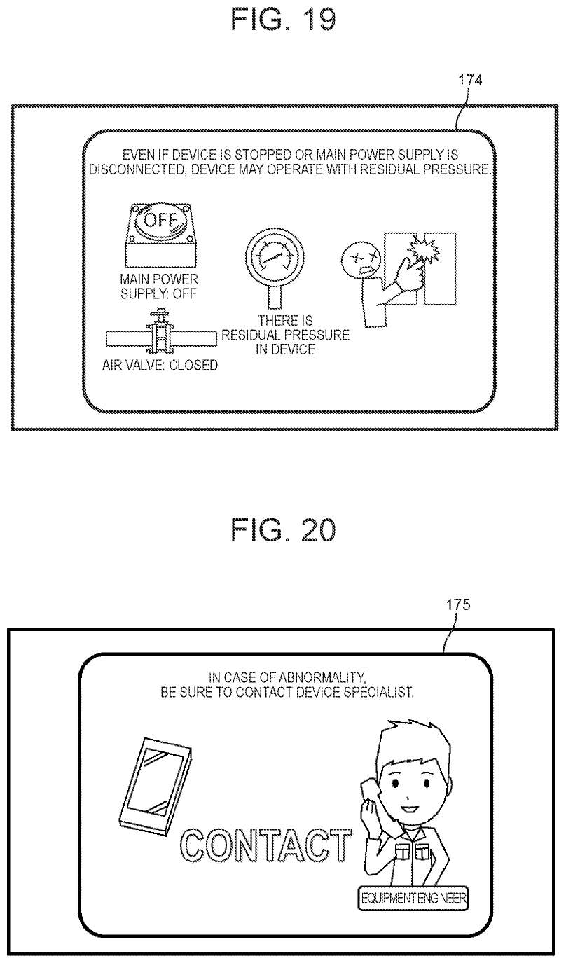

Next, in relation to the accident scenario, an action to be taken to prevent the accident or an appropriate action to illustrate a correct action to be taken when the accident occurs is presented (S225). FIG. 19 and FIG. 20 are diagrams illustrating examples of screens at the time of presenting a desirable action. For example, as respectively illustrated in FIG. 19 and FIG. 20, image 174 explaining cause of an accident, image 175 illustrating actions to be taken when the accident occurs, and the like are displayed. The presentations may be performed by using either a still image or a moving image. Further, the presentations may be performed in a virtual space. Further, explanation may be made by using sound.

As described above, according to the display system 100 of the present embodiment, educational effects can be improved and safety training can be effectively performed by a realistic experience using a virtual space. Further, the educational effect can be improved by an active movement of education target person 101.

Although a display system according to an embodiment is described above, the present disclosure is not limited to this embodiment. For example, display system 100 of the present disclosure can be used for safety education not only in a factory but also in a facility such as a school, a hospital, and a research facility.

That is, a display system of the present disclosure is a system that provides education relating to equipment of a facility. The display system includes a detector, a display, and an operator.

The detector detects position information of an education target person.

The display displays an image viewed from a viewpoint of the education target person corresponding to the position information, in a virtual space of the facility in which an education target object associated with the equipment and having a shape of the equipment is disposed.

The operator selects the education target object included in the image.

When the education target object is selected by operating the operator, the display displays educational content of equipment associated with the education target object.

A server of the present disclosure is a server for outputting educational content for providing education relating to equipment of a facility.

The server includes an acquisitor, an image output unit, and a content output unit.

The acquisitor acquires position information of an education target person from a detector.

The image output unit outputs an image viewed from a viewpoint of the education target person corresponding to the position information to the display, in a virtual space of the facility in which an education target object associated with the equipment and having a shape of the equipment is disposed.

The content output unit outputs educational content of equipment associated with the education target object to the display when the education target object included in the image is selected.

A display method of the present disclosure is a display method of displaying content for providing education relating to equipment of a facility.

The display method receives position information of an education target person detected by a detector, outputs information for displaying an image viewed from a viewpoint of the education target person corresponding to the position information to a display device, in a virtual space of the facility in which an education target object associated with the equipment and having a shape of the equipment is disposed, and outputs information for displaying educational content of equipment associated with the education target object to the display device when the education target object included in the image displayed on the display device is selected.

A device of the present disclosure is a device for providing education relating to equipment of a facility.

The device includes a processor and a memory.

The memory stores a program executable by the processor.

The processor uses the program stored in the memory to receive position information of an education target person from a detector, generate an image viewed from a viewpoint of the education target person corresponding to the position information, in a virtual space of the facility in which an education target object associated with the equipment and having a shape of the equipment is disposed, output the image to a display device, and output educational content of equipment associated with the education target object to the display device when the education target object included in the image is selected by operating an operator.

For example, a configuration of display system 100 illustrated in FIG. 2 is an example, and a process performed by one device may be performed by another device, a plurality of types of processing performed by one device may be performed dividedly by a plurality of devices, or a plurality of types of processing performed by a plurality of devices may be performed by a single device. For example, some or all of functions of server 102 may be included in headset 103.

Further, some or all of processors included in the respective devices included in the display system according to the above-described embodiments are typically realized as a large scale integration (LSI) which is an integrated circuit. These may be individually made into one chip or may be made into one chip so as to include some or all thereof.

Further, the integrated circuit is not limited to the LSI and may be realized by a dedicated circuit or a general-purpose processor. A field programmable gate array (FPGA) that can be programmed after manufacturing the LSI, or a reconfigurable processor that can reconfigure connection and setting of circuit cells inside the LSI may be used.

Further, in the above-described embodiment, each configuration element may be configured by dedicated hardware and may be realized by executing a software program suitable for each configuration element. Each configuration element may be realized as a program execution unit such as a central processing unit (CPU) or processor reads and executes a software program recorded in a recording medium such as a hard disk or a semiconductor memory.

Further, the present disclosure may be realized as each device included in a display system. Further, the present disclosure may be realized as a method such as an educational content display method or an education method performed by one or more devices included in the display system.

Further, division of the functional blocks in the block diagram is an example, and multiple functional blocks may be realized as one functional block, one functional block may be divided into multiple functional blocks, or some functions may be transferred to other functional blocks. Further, functions of a plurality of functional blocks having similar functions may be processed by single hardware, or software may be processed in parallel or in time division.

Further, an order in which the respective steps in a flowchart are performed is an example for specifically describing the present disclosure and may be an order other than the above-described order. Further, some of the above-described steps may be performed simultaneously (in parallel) with other steps.

As described above, the display system according to one or more aspects is described based on the embodiment, and the present invention is not limited to the embodiment. As long as it does not depart from the gist of the present disclosure, various modifications that can be considered by those skilled in the art are applied to the present embodiment, and forms configured by combining configuration elements in different embodiments may be included within the scope of one or more aspects.

As such, the present disclosure can provide a display system, a server, a display method, or a device that enables effective education.

### INDUSTRIAL APPLICABILITY

The present disclosure can be applied to a display system, for example, a system that provides safety education in a facility such as a factory.

### REFERENCE MARKS IN THE DRAWINGS

100 DISPLAY SYSTEM
101 EDUCATION TARGET PERSON
102 SERVER
103 HEADSET
104 CONTROLLER
105 POSITION SENSOR
106 NETWORK
121 STORAGE
122 ACQUISITOR
123 IMAGE OUTPUT UNIT
124 CONTENT OUTPUT UNIT
125, 131 NW COMMUNICATOR
132, 142 COMMUNICATOR
133 SPEAKER
134 DISPLAY
135, 144, 151 DETECTOR
141 OPERATOR
143 VIBRATOR
161 VIRTUAL SPACE
162, 162A, 162B, 162D EDUCATION TARGET OBJECT
162C NORMAL OBJECT
164 ICON
165 POINTER
166 RISK ASSUMING TRAINING SCREEN
167 RISK CANDIDATE
168 SELECTION MARK
169 DETERMINATION BUTTON
171 HAND
172 DRIVER
172a TUBE
173 QUESTION SCREEN
174, 175 IMAGE

1. A display system for providing education relating to equipment of a factory, the display system comprising:
a detector that detects position information of an education target person;
a display that displays an image viewed from a viewpoint of the education target person corresponding to the position information, in a virtual space of the factory in which an education target object associated with the equipment and having a shape of the equipment is disposed; and
an operator for selecting the education target object included in the image,
wherein, when the education target object is selected by operating the operator, the display displays educational content of the equipment associated with the education target object.

2. The display system of claim 1,
wherein the display
displays an icon on the education target object or around the education target object when the image includes the education target object, and
displays the educational content when the icon is selected by the operator.

3. The display system of claim 2,
wherein the display
displays a pointer pointing to a position on the image based on an operation of the education target person, and
displays the educational content by operating the operator in a state where the icon is pointed by the pointer.

4. The display system of claim 1,
wherein the display displays a pointer pointing to a position on the image based on an operation of the education target person, and displays the educational content by operating the operator in a state where the education target object is pointed by the pointer.

5. The display system of claim 1,
wherein the display
displays a pointer pointing to a position on the image based on an operation of the education target person,
displays an icon on the education target object or around the education target object when the education target object is pointed by the pointer, and
displays the educational content by operating the operator in a state where the icon is displayed.

6. The display system of claim 1,
wherein the educational content includes a virtual experience in the virtual space.

7. The display system of claim 6,
wherein the virtual experience includes a risk experience on the education target object.

8. The display system of claim 7,
wherein the educational content includes a question on the risk experience to the education target person.

9. The display system of claim 7,
wherein the educational content includes content relating to the risk experience and indicating an action to be taken by the education target person.

10. The display system of claim 1,
wherein the educational content includes content relating to the education target object and allowing the education target person to select a risky place.

11. The display system of claim 1,
wherein the virtual space is generated by using an image obtained by imaging the factory.

12. The display system of claim 1, further comprising:
a vibrator that vibrates the education target person according to content of the educational content.

13. A server for outputting educational content for providing education relating to equipment of a factory, the server comprising:
an acquisitor that acquires position information of an education target person from a detector;
an image output unit that outputs an image viewed from a viewpoint of the education target person corresponding to the position information to a display, in a virtual space of the factory in which an education target object associated with the equipment and having a shape of the equipment is disposed; and
a content output unit that outputs educational content of equipment associated with the education target object to the display when the education target object included in the image is selected.

14. A display method of displaying content for providing education relating to equipment of a factory, the display method comprising:
receiving position information of an education target person detected by a detector,
outputting information for displaying an image viewed from a viewpoint of the education target person corresponding to the position information to a display device, in a virtual space of the factory in which an education target object associated with the equipment and having a shape of the equipment is disposed; and
outputting information for displaying educational content of equipment associated with the education target object to the display device when the education target object included in the image displayed on the display device is selected.

15. A device for providing education relating to equipment of a factory, the device comprising:
a processor; and
a memory in which a program executable by the processor is stored,
wherein the processor uses the program stored in the memory to;
receive position information of an education target person from a detector;
generate an image viewed from a viewpoint of the education target person corresponding to the position information, in a virtual space of the factory in which an education target object associated with the equipment and having a shape of the equipment is disposed;
output the image to a display device; and
output educational content of equipment associated with the education target object to the display device when the education target object included in the image is selected by operating an operator.
